(19) United States
(12) Patent Application Publication
(10) Pub. No.: US 2003/0126293 A1
(43) Pub. Date: Jul. 3, 2003

(54) Dynamic user interface reformat engine

(76) Inventor: Robert Bushey, San Diego, CA (US)

Correspondence Address: HEWLETT-PACKARD COMPANY, Intellectual Property Administration, P.O. Box 272400, Fort Collins, CO, 80527-2400, US

(21) Appl. No.: 10/034,466

(22) Filed: Dec. 27, 2001

(51) Int. Cl. G06F 15/16

(52) U.S. Cl. 709/246; 709/250; 345/744

(57) ABSTRACT

The present invention discloses a system and method for an appliance network having format-neutral multimedia communication, the network comprising two or more appliances connected to the appliance network, each of the two or more appliances having interface information defining its multimedia capabilities and a communication protocol for communicating the interface information over the appliance network, wherein each of the two or more appliances comprises an application information base (AIB) for storing interface information for each of the two or more appliances connected to the appliance network, a network interface for communicating multimedia data over the appliance network, and a multimedia manager for translating the multimedia data into a compatible format.

### TECHNICAL FIELD

The present invention relates in general to software for formatting visual data and, more specifically, to reformatting software that dynamically reformats visual data dependent on the capabilities of a particular electronic appliance display.

### BACKGROUND OF THE INVENTION

The electronic community today is typically centered around the computer and/or personal computer (PC) for running many day-to-day tasks. Different computers or computer makers, as well as different software applications, may support any number of different formats for displaying data and information to users. Image and compression formats, including, but not limited to, graphics interchange format (GIF), portable network graphics (PNG), tagged image file format (TIFF), and joint photographic expert groups (JPEG) for still images and audio video interleaved (AVI) and moving pictures experts group (MPEG) for video images generally provide the display formatting information necessary for rendering such images onto the display of the computer. With the processing power and memory resources available on today's computers, it is usually not disadvantageous to store several format-specific viewers and utilities for processing and displaying each different display format available on the market.

Furthermore, a computer's basic input/output system (BIOS) includes basic level software routines for controlling the device-level display process. The display information from the display formats is converted into the specific device-level commands for activating or enabling certain pixels to obtain the appropriate image, colors, and hues on the particular display device. An analogous type of software routine is also generally found with printers and/or printer drivers for mapping the colors defined in the image information into a set of instructions for activating the appropriate colored inks and ink combinations found within each particular printer to obtain reproduction of the various, displayed images.

In network and Internet situations, file sharing typically creates the need for each of the computers on the network to have the appropriate format-specific viewers for displaying the different formats of any of the shared files. In today's networks, computers and PCs are typically in communication with each other over the network. Thus, each network node is generally a computer with the available processing power and memory resources for storing and running all of the necessary format-specific viewers. However, networks are generally evolving into more than simply a group of connected computers and/or PCs. Electronic appliances, such as printers, copiers, handheld computers, cell phones, televisions, and the like are increasingly being included as independent member-nodes on networks.

Appliance networks include devices that do not typically have the processing power or memory resources of a computer or PC. Because of this limitation, file sharing across a network including electronic appliances generally presents a much more difficult problem. A different viewer for each possible image or display format may not be feasible on the appliances. Moreover, each different appliance may have a different color gamut requiring color and hue translations from one appliance to the next. No systems or methods currently exist that facilitate the reformatting of image data shared across such networks.

### BRIEF SUMMARY OF THE INVENTION

The present invention relates to a system and method for an appliance network having format-neutral multimedia communication, the network comprising two or more appliances connected to the appliance network, each of the two or more appliances having interface information defining its multimedia capabilities and a communication protocol for communicating the interface information over the appliance network, wherein each of the two or more appliances comprises an application information base (AIB) for storing interface information for each of the two or more appliances connected to the appliance network, a network interface for communicating multimedia data over the appliance network, and a multimedia manager for translating the multimedia data into a compatible format.

### BRIEF DESCRIPTION OF THE DRAWINGS

FIG. 1 is a block diagram illustrating a preferred embodiment consistent with the teachings of the present invention;

FIG. 2 is a block diagram detailing the conversion manager block from FIG. 1;

FIG. 3 is a block diagram detailing the resolution manager block from FIG. 1;

FIG. 4 is a block diagram detailing an alternative embodiment of the appliance manager block from FIG. 1;

FIG. 5 is a perspective view illustrating a system configured according to one embodiment consistent with the teachings of the present invention; and

FIG. 6 is a flow chart presenting the steps involved in implementing an embodiment of the present invention.

### DETAILED DESCRIPTION OF THE INVENTION

FIG. 1 is a block diagram illustrating a preferred embodiment consistent with the teachings of the present invention. Network 11 may also have other appliances, such as remote appliances 12-14, connected into the network. Network 11 generally includes a group of limited capability appliances; however, may also, in some configurations, include a limited number of computers.

Local appliance 10 preferably includes appliance manager 100 for controlling the communication functions with network 11. Local appliance 10 also preferably includes appliance information base (AIB) 101 for storing interface information or settings of the other appliances connected to network 11 and codec database 102 for storing codecs. In operation, as local appliance 10 is connected to network 11, appliance manager 100 preferably initiates a communication session with network 11, and each of remote appliances 12-14. During this communication session, local appliance 10 preferably retrieves all of the capabilities and interface settings of each of remote appliances 12-14. Additionally, local appliance 10 preferably provides information on its different capabilities to each of remote appliances 12-14.

The capability or interface information includes such information as what data formats remote appliances 12-14 support, what resolutions each supports, what colors each supports, what video formats each supports, and so on. Preferably this information is communicated in an organized packet or data structure in a communication protocol or format. Thus, the capability information may preferably be communicated in a standardized form. These data structures are then preferably stored on AIB 101. The resulting system preferably allows each network appliance, such as local appliance 10 and remote appliances 12-14 to maintain a dynamic database of the supportable functions and capabilities of each of the other devices on network 11. This information is then preferably used by local appliance 10 in processing any visual or multimedia information or data communicated across network 11.

For example, if remote device 12 sends media information representing a still picture using the GIF format, the media information would travel across network 11 to appliance manager 100 of local appliance 10. From appliance manager 100, the media information preferably moves to reception manager 103. Reception manager 103 preferably determines the device from which the media information originated using the originating address information included in the communicated data packets. Reception manager 103 preferably accesses AIB 101 to find the specific formats and capabilities supported by remote appliance 12, and then signals codec processor 104 with the appropriate format codecs to retrieve from codec database 102. Using the appropriate GIF format codec, codec processor 104 preferably decompresses the media data into the actual raw visual information describing the still image. After decompressing the communicated media information, local appliance 10 must preferably convert the colors described according to the gamut space of remote appliance 12 into corresponding colors of the gamut space of local appliance 10. A gamut space is basically the region of color that is reproducible by any given device. Different devices may generally have different gamut spaces yet still be able to reproduce images that appear to be the same or similar, but which are created using different color schemes and/or combinations from each device. Conversion manager 200 preferably converts the color instructions from the communicated media data, which was created using the gamut space of remote appliance 12, into the color instructions for the gamut space of local appliance 10. Conversion manager 200 preferably uses the gamut information from AIB 101 pertaining to remote appliance 12 to determine the appropriate gamut conversion algorithm to use.

In addition to the potential differences in each device's gamut space, each device may also possess differing display resolutions. For instance, a hand held computer may have a display resolution of 240×320 pixel display for a 76.8 kpixel resolution, while a mobile phone may have a display resolution of 36×24 pixel display for a 864 pixel resolution. Each such device may preferably be connected to network 11 and capable of communicating visual information. However, the resolution differences may potentially cause a problem in displaying the communicated information. To resolve this problem, local appliance 10 also preferably includes resolution manager 300. Resolution manager 300 preferably converts the resolution of the incoming visual data to the displayable resolution of local appliance 10 responsive to the resolution information provided in AIB 101 for remote appliance 12. Thus, if the incoming visual information has come from a mobile phone with less than a 1 kpixel resolution and local appliance 10 were comprised of a hand held computer with a resolution greater than 76 kpixel, resolution manager 300 preferably up-converts the resolution of the incoming visual information to the 76 kpixel of local appliance 10. Similarly, if the incoming visual information has come from a high-definition television (HDTV) with a 1920×1080 pixel display for more than a 2 Megapixel resolution and local appliance 10 were still a hand held computer with a resolution greater than 76 kpixel, resolution manager 300 preferably down-converts the resolution of the incoming visual information to the 76 kpixel of local appliance 10.

Once the incoming visual information is converted into the appropriate gamut space and resolution of local appliance 10, it can then be communicated to the display of local appliance 10 through display interface 105. Display interface 105 may also include a codec processor to preferably convert the raw instructions into the compatible display format of local appliance 10. However, it should be noted that some displays may not require display interface 105 to compress or manipulate the new visual information any further.

It should be noted that alternative embodiments of the present invention may only include a one-way transcoding function, such as the functions as described to this point. Each connected appliance receives any multimedia data format in any of the formats compatible with any other of the connected network appliances and further transcodes or converts the multimedia information into a format compatible for display. However, other preferred embodiments of the present invention may also include two-way transcoding to accommodate network appliances that have very limited memory and processing resources.

The system depicted in FIG. 1 illustrates such an embodiment implementing two-way transcoding. Two-way transcoding preferably allows a single network appliance, such as local appliance 10, to convert outgoing visual data or multimedia information into a format compatible with the destination network appliance. In this operation, network appliances with limited processing and memory resources may also preferably view the multimedia information communicated from an incompatible display.

For example, as local appliance 10 initiates a communication link to send visual data to remote appliance 13, which is a limited resource appliance, such as a microwave oven or other such limited resource device, transmission manager 106 preferably accesses AIB 1101 in order to retrieve the data structure corresponding to remote appliance 13 that contains the necessary device information. Using the resolution information for remote appliance 13 from AIB 101, resolution manager 300 preferably determines how to convert the outgoing visual data into the appropriate resolution. Depending on whether the resolution at remote appliance 13 is higher or lower than local appliance 10, resolution manager 300 will preferably either up-convert or down-convert the visual data. Conversion manager 200 then preferably accesses the gamut information for remote appliance 13 from the device information retrieved from AIB 101, to determine which of the specific gamut conversion algorithms or techniques to use in transcoding the color instructions into the appropriate gamut space for remote appliance 13. Using the display format information for remote appliance 13, codec processor 104 preferably retrieves the appropriate visual format codec to transcode the visual data into an image format compatible with remote appliance 13. The transcoded visual data is then preferably communicated by appliance manager 100 across network 11 to remote appliance 13, wherein remote appliance 13 may preferably display the communicated visual information without needing to convert or transcode the visual data locally.

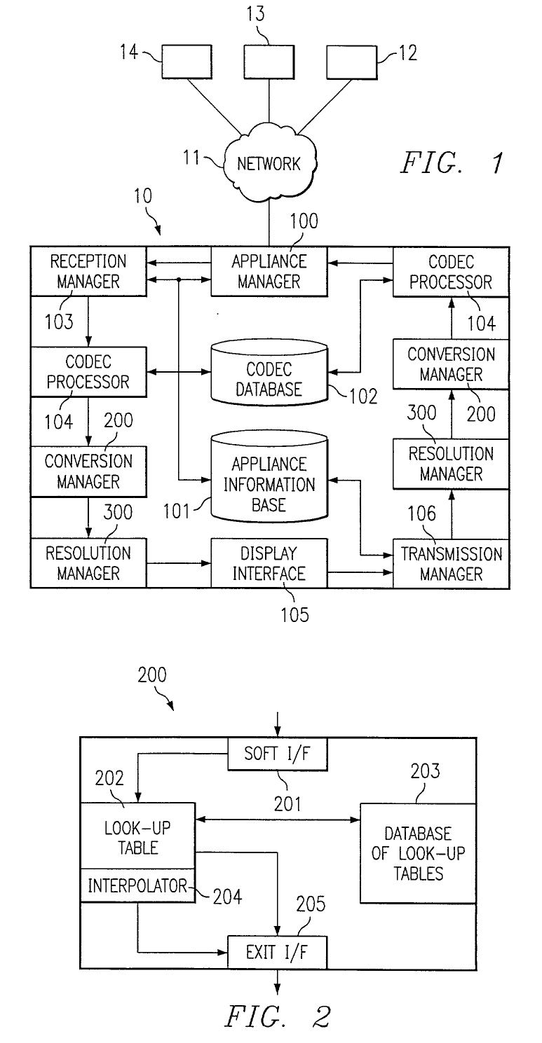

FIG. 2 is a block diagram detailing the conversion manager block from FIG. 1. FIG. 2 illustrates one method, i.e., the look-up table method, for conversion manager 200 to transcode the points of one gamut space into corresponding and/or similar points of another gamut space. The communicated visual data enters conversion manager 200 through soft interface 201. Using the gamut information stored in AIB 101 (FIG. 1), look-up table database 203 is preferably searched for the appropriate table corresponding to the remote device. The visual data is then preferably transcoded point by point in the three-dimensional (3D) color space of remote appliance 13. The first 3D point passes to look-up table 202. Look-up table 202 comprises a set of points that correspond to the remote gamut space corresponding to a set of points corresponding to the local gamut space. Therefore, the first 3D point of remote appliance 13 is used to preferably find the corresponding 3D point in the local gamut space. If the exact point is found explicitly within look-up table 202, the new 3D point is communicated to exit interface 205 for continued processing in local appliance 10 (FIG. 1).

It should be noted that because look-up table 202 can only provide a reasonable number of corresponding gamut points, conversion manager 200 also preferably includes interpolator 204. Interpolator 204 preferably calculates a corresponding 3D point in the local gamut space located between the closest points, around the point being converted, defined in look-up table 202 in order to estimate or interpolate the exact location of the 3D point in the local gamut space. After calculating the new 3D point, it is also preferably communicated to exit interface 205 for continued processing in local appliance 10 (FIG. 1).

It should also be noted that conversion manager 200 may operate as a one-way conversion or a two-way conversion algorithm. In one-way operation, conversion manager 200 operates only to convert remotely communicated visual data into the gamut space of the local appliance. In two-way operation, conversion manager 200 may preferably convert the remote visual data into the local color gamut space and also preferably converts the local color gamut space into the gamut space of a targeted remote appliance.

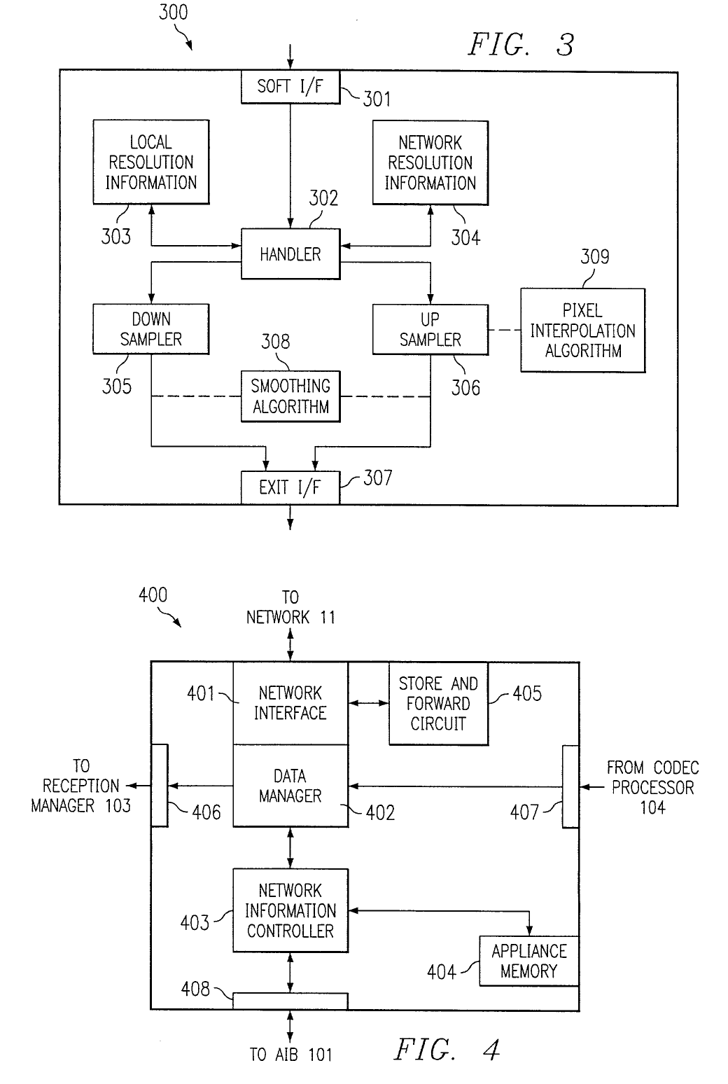

FIG. 3 is a block diagram detailing the resolution manager block from FIG. 1. The communicated visual data preferably enters resolution manager 300 through soft interface 301. The visual data is then preferably communicated to handler 302. Using the resolution information stored in AIB 101 (FIG. 1), handler 302 preferably accesses detailed information regarding the resolutions necessary for the local device and for the remote device through local resolution information 303 and network resolution information 304. For example, as the remote visual data enters handler 302, the resolution information concerning the remote appliance from AIB 101 (FIG. 1) preferably instructs handler 302 of the type of resolution found in the visual data. Handler 302 then preferably accesses network resolution information 304 to obtain more detailed information regarding the type of resolution, e.g., the aspect ratio of the remote appliance, the number of pixels or dots per square inch, and the like. Handler 302 then preferably accesses local resolution information 303 to obtain similar details regarding the resolution information for the local appliance. Based then on the processing and comparison of the two sets of the resolution information, handler 302 prefereably either communicates the visual data to down-sampler 305 or up-sampler 306.

When the visual data entering resolution manager 300 has a higher resolution than the local appliance, handler 302 preferably sends the visual data through down-sampler 305. Down-sampler 305 preferably reduces the resolution of the incoming visual data to the resolution displayable on the local appliance display. There are many known methods of down-sampling to drop certain ones of the pixels while preserving the general appearance of the original visual information that may be employed. Down-sampler 305 may also preferably include smoothing algorithm 308 for processing the down sampled visual data into a smoother image. There are also many known methods of smoothing visual data that has been compressed or reduced in resolution that may be used.

If the incoming visual information entering resolution manager 300 has a lower resolution than the local appliance, handler 302 preferably sends the visual information through up-sampler 304. Up-sampler 304 preferably increases the resolution of the incoming visual information to the resolution displayable on the local appliance display. There are also many known methods of up-sampling for inserting selected colors and hues of pixels to increase the resolution of the entire image. These methods typically provide for maintaining the image as true to the original as possible. Up-sampler 305 may also preferably include pixel interpolation algorithm 309 for analyzing the gradient of the image elements. Using the gradient determinations, up-sampler 305 would preferably add the correct number of appropriately colored and hued pixels in order to smoothly transition the added resolution into the existing resolution of the original image. Up-sampler 305 may also preferably use smoothing algorithm 308 to smooth the processed image data. Once the data is appropriately processed into the correct resolution, the processed data exits resolution manager 300 through exit interface 307.

It should be noted that resolution manager 300 may also preferably operate as a one-way conversion or a two-way conversion apparatus, just as with conversion manager 200 (FIG. 2). In one-way operation, resolution manager 300 operates only to convert remotely communicated visual data into a resolution compatible with the local appliance. In two-way operation, resolution manager 300 may preferably convert the remote visual data into the local resolution and also preferably converts the local resolution into a compatible resolution of a targeted remote appliance.

FIG. 4 is a block diagram detailing an alternative embodiment of the appliance manager block from FIG. 1. Appliance manager 400 preferably controls the interaction of local appliance 10 with network 11 and remote appliances 12-14 (FIG. 1). Network interface 401 provides the necessary physical layer interface with network 11. It ensures that all of the necessary network protocol signals are either added to or subtracted from the electronic information communicated across network 11. Data manager 402 preferably controls the movement of the data within appliance manager 400. As electronic data arrives from network 11 via network interface 401, data manager 402 preferably determines whether the data is image data addressed to the local display or whether the data is network administrative data addressed to AIB 101. Depending on which type of data is received, data manager 402 preferably either communicates the information out to reception manager 103 through interface 406 or passes the information to network information controller (NIC) 403 for further administrative processing.

NIC 403 preferably drives all administrative communication with network 11. As local appliance 10 (FIG. 1) connects to network 11, NIC 403 detects the connection and preferably transmits communication signals through both data manager 402 and network interface 401 to network 11. These communication signals are received by each appliance connected to network 11. In response to the received communication signals, each network-connected appliance preferably sends information regarding the attributes of the remote appliances to local appliance 10 (FIG. 1). All of the remote appliance information is preferably passed to NIC 403, which, thereafter, communicates the appliance information to AIB 101 through interface 408.

Because NIC 403 controls all network communication from local appliance 10 (FIG. 1), it is in communication with appliance memory 404 where all of the available network command signals or protocol statements are stored. As NIC 403 parses query statements, communication signals, or any other network administrative signals, it preferably accesses appliance memory 404 to assemble the appropriate codes or signals to properly implement the communication session determined by NIC 403.

Data manager 402 also handles image data received from codec processor 104 when electronic information is being communicated from local appliance 10 (FIG. 1) to one or more of the remote devices. After entering appliance manager 400 through interface 407, data manager 402 preferably receives the communicated data and passes it to network interface 401. Network interface 401 assembles the appropriate network protocol commands and signals onto the data and communicates it onto network 11.

It should be noted that alternative embodiments of the present invention may be configured to allow incoming image data to be promptly re-transmitted onto another network device without receiving any processing. Such an alternative embodiment, as shown in FIG. 4, may preferably include store and forward circuit 405. In operation, as the communicated image data is received from network 11, network interface 401 sends a copy of the incoming data to data manager 402 for local processing and a copy to store and forward circuit 405. Store and forward circuit 405 preferably stores the data in localized memory and then communicates the stored data back to network interface 401 for transmission back to network 11 and addressed at another remote appliance.

Store and forward circuit 405 preferably prevents image data from being lost or corrupted while resident at local appliance 10 (FIG. 1). As noted above, local appliance 10 (FIG. 1), may preferably up-sample or down-sample in order to convert the remote image data into a format compatible for display on the local device. Once such sampled image data is either added or lost, it would be practically impossible to recreate the exact image data that was received from the image data processed at the local device. Thus, any image data that would be reconstituted at a local device and then communicated to another device would likely loose image quality.

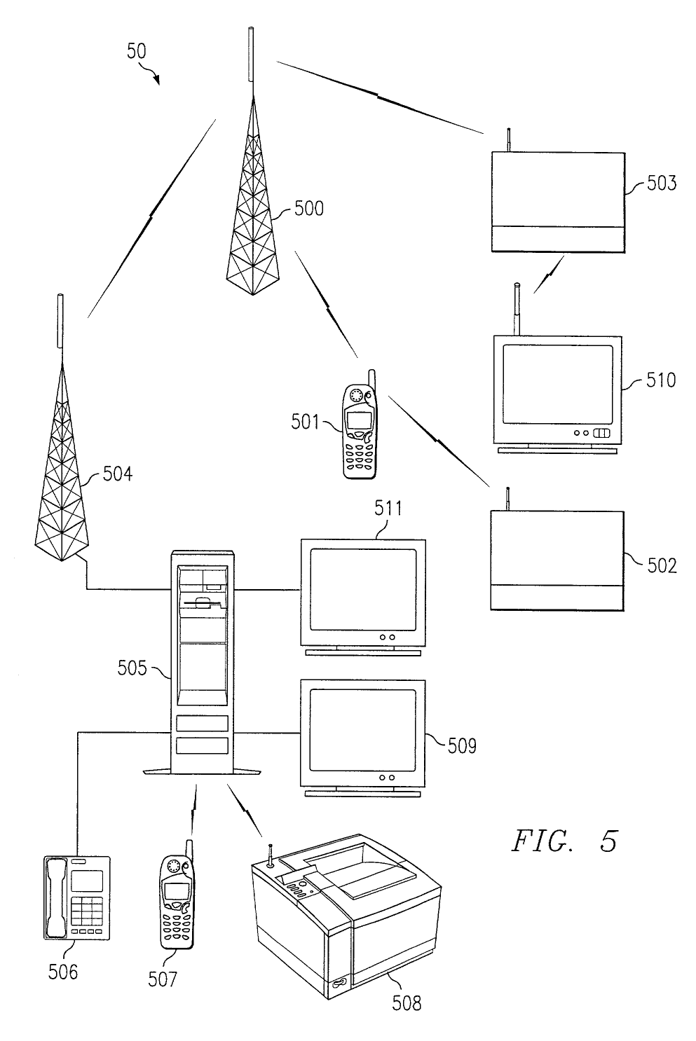

FIG. 5 is a perspective view illustrating a system configured according to one embodiment consistent with the teachings of the present invention. Appliance network 50 comprises both land line and wireless communication facilities. In one example of operation, as each appliance accesses appliance network 50, appliance compatibility information for each such connected appliance is preferably exchanged between all of the connected appliances. Transmitter 500 transmits a point-to-multipoint HDTV signal to any appliance capable of connecting to appliance network 50. Mobile phone 501, which is video-enabled, receives the HDTV signal. As the signal is received, mobile phone 501 preferably interprets the received signal and transcodes the color information into the color gamut space of mobile phone 501. Because of the size and reduced processing power of mobile phone 501, its display is only capable of a limited resolution. Therefore, mobile phone 501 preferably also down-samples the signal for presentation on the display. Once the incoming HDTV signal has been color-translated and down-sampled, it is displayed on mobile phone 501.

In one embodiment of the present invention, mobile phone 501 passes the received HDTV on to HDTV 502. Utilizing a signal memory, mobile phone 501 receives the signal, processes one copy of the signal for local use, temporarily stores another copy in the signal memory and then forwards the stored copy of the signal exactly as received from transmitter 500 to HDTV 502. Upon receipt of the forwarded signal, HDTV 502 may preferably directly display the compatible signal.

HDTV 503 may also preferably receive the HDTV signal transmitted from transmitter 500. In an alternative embodiment of the present invention, HDTV 503 may not only directly display the received signal, but, using the appliance compatibility information received from analog TV 510, may also preferably pre-process the HDTV signal by transcoding the color gamut space of HDTV 503 into the color gamut space of analog TV 510. HDTV 503 also preferably down-samples the resolution of the HDTV signal to the resolution compatible with analog TV 510. Therefore, HDTV 503 may forward the processed signal to analog TV 510 which can then be directly displayed without any further processing.

It should be noted that additional processing may be necessary for communication of visual information between appliances. For instance, in the above-described example a digital-to-analog conversion would be necessary to communicate the image signal from HDTV 503 to analog TV 510.

It should be noted that any type of electronic appliance may connect to appliance network 50. As shown in FIG. 5, transmitter 504 receives the HDTV signal from transmitter 500. Transmitter 504 supplies an appliance subnetwork comprising server 505, analog TV 509, land line telephone 506, mobile phone 507, and multipurpose printer 508. Using the color translation schemes and sampling functions of the present invention, a signal such as the HDTV signal from transmitter 500 may preferably be viewed and/or displayed on any of server 505 display 511, analog TV 509, telephone 506 display, mobile phone 507 display, and multipurpose printer 508 display. Depending on the resolution and color gamut space of the local appliance, the transcoded signal may not be displayed with a quality appearance but may be viewed without necessity of additional software viewers or processing power.

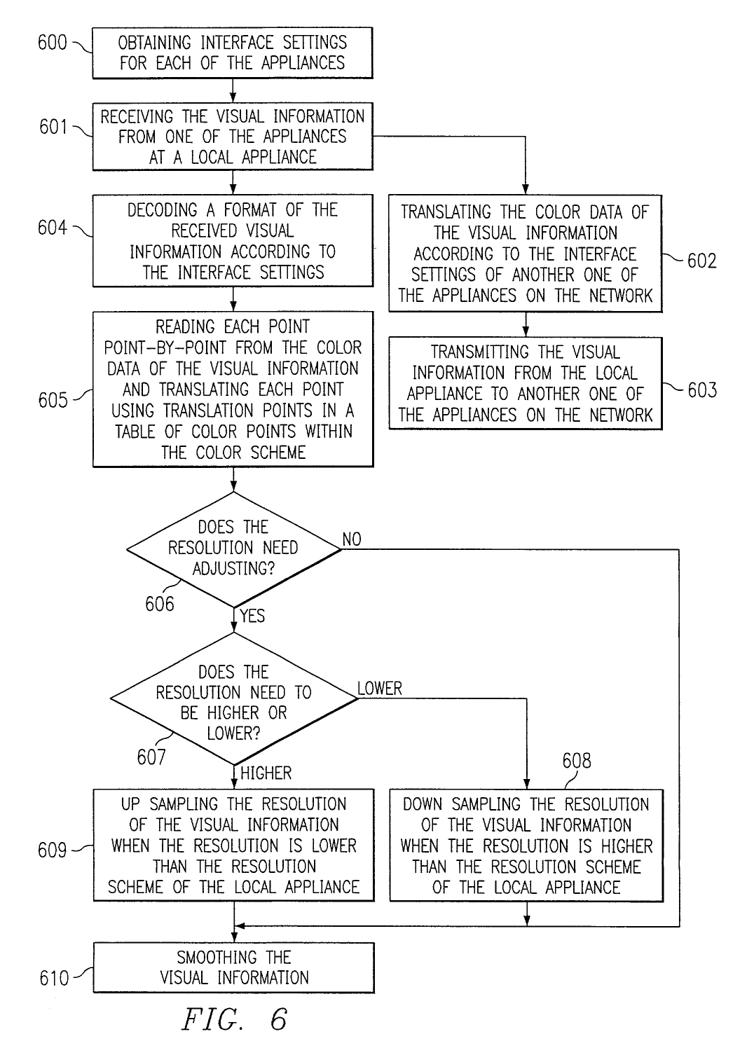

FIG. 6 is a flow chart presenting the steps involved in implementing an embodiment of the present invention. In step 600, interface settings are preferably obtained by a local appliance for each of the appliances. Visual information is then received from one of the appliances at the local appliance, in step 601. In one possible feature of a preferred embodiment of the present invention, the visual information is transmitted from the local appliance to one of the appliances on the network, in step 603. Prior to the transmission in step 603 one embodiment consistent with the teachings of the present invention may preferably translate the color data of the visual information according to the interface settings of another one of the appliances on the network that will receive the transmission. In step 604, any format of the received visual information is preferably decoded according to the interface settings. In step 605, each point of the color data is then read point-by-point from the visual information and is translated using translation points in a table of color points within the color scheme. The system according to the present embodiment then determines whether the resolution of the visual information needs to be adjusted in step 606. If not, the visual information is smoothed in step 610 and the process is complete. However, if the resolution must be adjusted, the system according to the present embodiment determines, in step 607, whether the resolution must be lowered or made higher. If the resolution of the visual information is higher than the resolution scheme of the local appliance, the resolution of the visual information is down sampled in step 608 to the level of the local appliance. Conversely, if the resolution of the visual information is lower than the resolution scheme of the local appliance, the resolution of the visual information is up-sampled in step 609 to the higher level of the local appliance. In step 610, the visual information, whether adjusted or not, is preferably smoothed to improve the quality of the image.

It should be noted that many different known methods for translating the color gamut space data may be used to convert the color data into another color gamut space. Furthermore, many different known methods for up-sampling, down-sampling, and smoothing may be implemented into alternative embodiments of the present invention.

What is claimed is:

1. An appliance network having format-neutral multimedia communication, said network comprising:
two or more appliances connected to said appliance network, each of said two or more appliances having interface information defining its multimedia capabilities;
a communication protocol for communicating said interface information over said appliance network, wherein each of said two or more appliances comprises:
an application information base (AIB) for storing interface information for each of said two or more appliances connected to said appliance network;
a network interface for communicating multimedia data over said appliance network; and
a multimedia manager for translating said multimedia data into a compatible format.

2. The appliance network of claim 1 wherein said communication protocol prompts each of said two or more appliances to communicate said interface information upon connecting to said appliance network.

3. The appliance network of claim 1 further comprising:
a communication configuration, said communication configuration comprising at least one of:
a point-to-point configuration;
a point-to-multipoint configuration;
a ring configuration; and
a spoke configuration.

4. The appliance network of claim 3 wherein said communication configuration is selected by one of said two or more appliances initiating communication of said multimedia data.

5. The appliance network of claim 1 wherein said communication protocol provides for each of said two or more appliances to communicate all of its interface information to each other of said two or more appliances connected to said appliance network when said each of said two or more appliances initially connects to said appliance network.

6. The appliance network of claim 1 wherein said multimedia manager comprises:
at least one coding-decoding application for converting a format of received multimedia data into said compatible format responsive to said interface information;
a gamut mapping application for translating said multimedia data onto a local user interface; and
a resolution application for regulating a resolution of said multimedia data into a compatible resolution for said local user interface.

7. The appliance network of claim 1 wherein said multimedia data is translated into said compatible format for each of said two or more appliances receiving said multimedia data by one of said two or more appliances transmitting said multimedia data over said appliance network.

8. The appliance network of claim 1 wherein said multimedia data is translated into said compatible format for each of said two or more appliances receiving said multimedia data by one of:
one of said two or more appliances transmitting said multimedia data over said appliance network; and
said each of said two or more appliances receiving said multimedia data;
responsive to said interface information.

9. A method for dynamically reformatting multimedia information in a network of appliances comprising the steps of:
obtaining interface settings for each of said appliances;
receiving said multimedia information from one of said appliances at a local appliance;
decoding a format of said received multimedia information according to said interface settings;
translating color data of said multimedia information into a color scheme of said local appliance; and
adjusting a resolution of said multimedia information into a resolution scheme of said local appliance.

10. The method of claim 9 wherein said translating step comprises the steps of:
reading a point from said color data of said multimedia information; and
looking up a translation point in a table of color points within said color scheme.

11. The method of claim 10 further comprising the steps of:
substituting said translation point into said multimedia information when said translation point is found in said table; and
interpolating an estimated color point corresponding to said point from said multimedia information.

12. The method of claim 9 wherein said translating step comprises the step of:
calculating a translation point using a gamut mapping formula.

13. The method of claim 9 wherein said adjusting step comprises the steps of:
down-sampling said resolution of said multimedia information when said resolution is higher than said resolution scheme of said local appliance; and
up-sampling said resolution of said multimedia information when said resolution is lower than said resolution scheme of said local appliance.

14. The method of claim 13 further comprising the step of:
smoothing said multimedia information.

15. The method of claim 9 further comprising the steps of:
adjusting said resolution scheme of said local appliance into a remote resolution scheme;
translating said color scheme of said local appliance into a remote color gamut space;
coding said multimedia information into a remote visual format according to said interface settings; and
transmitting said multimedia information from said local appliance to another one of said appliances on said network.

16. The method of claim 9 further comprising the steps of:
copying said received multimedia information; and
transmitting said copied multimedia information to one of said appliances on said network.

17. A dynamic reformatting engine for processing image data transmitted on an appliance network:
code for managing communication from an appliance on said appliance network;
a memory for storing appliance compatibility information received from each of said appliances on said appliance network;
code for interpreting at least one format of said image data responsive to said appliance compatibility information;
code for mapping points from one color gamut space to another color gamut space; and
code for adjusting a resolution of said image data into another resolution.

18. The dynamic reformatting engine of claim 17 further comprising:
code for smoothing said image data after said image data manipulated by said appliance.

19. The dynamic reformatting engine of claim 17 further comprising:
code for processing said image data at one of said appliances for display on another of said appliances according to appliance compatibility information corresponding to said another of said appliances.

20. The dynamic reformatting engine of claim 17 further comprising:
a signal divider for making a copy of said image data; and
code for communicating said copy of said image data to another of said appliances without any further processing to said copy.

21. A network appliance capable of dynamically reformatting visual data communicated across a network of appliances, said network appliance comprising:
an appliance manager for obtaining interface information for each appliance connected to said network of appliances;
an appliance information base for storing said interface information;
at least one codec for transcoding visual data formats responsive in part to said interface information;
a conversion manager for mapping said visual data onto a local user interface of said network appliance; and
a resolution manager for adjusting said visual data to a resolution of said local user interface.

22. The network appliance of claim 21 further comprising:
a transmission manager for managing the transcoding of visual data transmitted from said network appliance into a format compatible with another appliance connected to said network of appliances responsive to said interface information.

23. The network appliance of claim 21 further comprising:
a reception manager for managing the transcoding of visual data received from another appliance on said network of appliances into a format compatible with said local user interface.

24. The network appliance of claim 21 wherein said resolution manager includes:
a down-sampler for reducing said resolution of said visual data when said resolution of said visual data exceeds said resolution of said local user interface; and
an up-sampler for increasing said resolution of said visual data when said resolution of said visual data is lower than said resolution of said local interface.

25. The network appliance of claim 24 wherein said resolution manager further includes:
a smoothing algorithm for blending said visual data.

26. The network appliance of claim 21 further comprising:
a signal splitter for passing a non-reformatted copy of said visual data to another appliance on said network of appliances.

27. The network appliance of claim 26 further comprising:
a store and forward device for storing said non-reformatted copy of said visual data and forwarding said data to said another appliance.

28. The network appliance of claim 21 wherein said conversion manager includes:
a look up table for mapping a remote gamut point of said communicated visual data into a local gamut point within a local gamut space of said network appliance; and
an interpolator for interpolating said remote gamut point into said local gamut space when a location of said local gamut point is not disposed in said look up table.

29. A method for reformatting media information in a networked appliance comprising the steps of:
receiving said media information at a network interface;
decoding a format of said received media information according to stored user interface information;
mapping color points from said media information onto a color system used by said networked appliance; and
adapting a resolution of said media information according to a user interface of said networked appliance.

30. The method of claim 29 further comprising:
transmitting user interface information for said networked appliance when said networked appliance connects to a network.

31. The method of claim 29 further comprising:
receiving user interface information for all appliances connecting to a network on which said networked appliance is connected; and
storing said received user interface information.

32. The method of claim 29 further comprising:
smoothing said received media information prior to displaying said received media information on said user interface of said networked appliance.

33. The method of claim 29 wherein said mapping step comprises the steps of:
reading each of said color points of said media information;
looking up a translation color point that corresponds to said read color point;
substituting said translation color point into said media information when said translation color point is found; and
interpolating an estimated translation color point into said media information when said translation color point is not found.

34. The method of claim 33 wherein said looking up step comprises:
looking up said translation color point in a look-up table.

35. The method of claim 29 wherein said adapting step comprises the steps of:
determining when said resolution of said media information is not compatible with said user interface of said networked appliance;
down-sampling said resolution when said resolution is higher than said user interface; and
up-sampling said resolution when said resolution is lower than said user interface.

36. The method of claim 31 farther comprising the steps of:
adjusting said resolution of said media information according to said stored interface information for another appliance connected to said network;
translating said color system of said networked appliance according to said stored interface information for said another appliance connected to said network;
coding said media information according to said stored interface information for said another appliance connected to said network; and
transmitting said multimedia information from said networked appliance to said another appliance connected to said network.

37. The method of claim 29 further comprising the steps of:
copying said received media information; and
transmitting said copied media information through said network interface.
